(19) United States
(12) Patent Application Publication
(10) Pub. No.: US 2021/0261766 A1
(43) Pub. Date: Aug. 26, 2021

(54) Moisture-Curable Flame Retardant Composition for Wire and Cable Insulation and Jacket Layers

(71) Applicants: Dow Global Technologies LLC, Midland, MI (US); Dow Silicones Corporation, Midland, MI (US); Rohm and Haas Company, Collegeville, PA (US)

(72) Inventors: Yichi Zhang, Collegeville, PA (US); Xindi Yu, Collegeville, PA (US); Gerald Lawrence Witucki, Auburn, MI (US); Wen-Shiue Young, Collegeville, PA (US); Bharat I. Chaudhary, Collegeville, PA (US)

(21) Appl. No.: 17/256,277

(22) PCT Filed: Jun. 26, 2019
(86) PCT No.: PCT/US2019/039324

§ 371 Date: Dec. 28, 2020

Related U.S. Application Data
(60) Provisional application No. 62/691,804, filed on Jun. 29, 2018.

(51) Int. Cl. C08L 51/06; C08F 230/08; C08K 3/016; C08L 83/06; C08K 5/57; H01B 3/44; H01B 3/46; C08K 5/00

(52) U.S. Cl. CPC C08L 51/06; C08F 230/085; C08K 3/016; C08L 83/06; C08K 5/57; H01B 3/441; C08L 2312/08; C08K 5/005; C08L 2203/202; C08L 2201/02; C08L 2205/02; C08L 2205/03; H01B 3/465

(57) ABSTRACT

A jacket layer for a coated conductor is composed of (A) a crosslinked silane-functionalized polyolefin; (B) a flame retardant; (C) a silicone blend comprising (i) an MQ silicone resin, and (ii) a silicone other than an MQ silicone resin; (D) optionally, an antioxidant; and (E) from 0.000 wt % to 10 wt % of a silanol condensation catalyst.

### FIELD OF THE DISCLOSURE

This disclosure relates to moisture-curable compositions. In one aspect, the disclosure relates to moisture curable composition based on silicone blends, while in another aspect, the disclosure relates to insulation or jacket layers for wires and cables comprising a moisture-curable composition and coated conductors including the same.

### BACKGROUND

Moisture-curable compositions containing a silane-functionalized polyolefin (e.g., a silane-grafted polyolefin) are frequently used to form coatings, particularly insulation or jacket layers, for wires and cables. Many flame retardant compositions include fillers such as metal hydrates, carbonates and silica and yield less than desirable burn performance and/or mechanical properties.

To improve properties, a silicone can be added to the composition. The addition of a silicone improves some properties, including tensile strength. While such formations are suitable for certain requirements, these formulations exhibit a stability issue caused by high sweat-out of silicone fluid (as measured by surface silicone fluid extraction). Consequently, the art recognizes the need for flame retardant compositions that use silicone in moisture-curable compositions and which exhibit sufficiently low values of surface silicone fluid extraction.

### SUMMARY

The disclosure provides a crosslinkable composition for a jacket layer for a coated conductor. In an embodiment, the crosslinkable composition comprises (A) a silane-functionalized polyolefin; (B) a flame retardant; (C) a silicone blend comprising (i) an MQ silicone resin, and (ii) a silicone other than an MQ silicone resin; (D) optionally, an antioxidant; and (E) a silanol condensation catalyst.

In another embodiment, the disclosure provides a jacket layer for a coated conductor. In an embodiment, the jacket layer comprises (A) a crosslinked silane-functionalized polyolefin; (B) a flame retardant; (C) a silicone blend comprising (i) an MQ silicone resin, and (ii) a silicone other than an MQ silicone resin; (D) optionally, an antioxidant; and (E) from 0.000 wt % to 10 wt % of a silanol condensation catalyst, based on the total weight of the jacket layer.

In another embodiment, the disclosure provides a coated conductor. In an embodiment, the coated conductor comprises a conductor, and a coating on the conductor, the coating comprising (A) a crosslinked silane-functionalized polyolefin; (B) a flame retardant; (C) a silicone blend comprising (i) an MQ silicone resin, and (ii) a silicone other than an MQ silicone resin; (D) optionally, an antioxidant; and (E) from 0.000 wt % to 10 wt % of a silanol condensation catalyst, based on the total weight of the coating.

### BRIEF DESCRIPTION OF THE DRAWINGS

FIG. 1 is a graph illustrating tensile strength as a function of the percent by weight of MQ silicone resin in the silicone blend for CS1-3 and IE1-2.

FIG. 2 is a graph illustrating tensile elongation as a function of the percent by weight of MQ silicone resin in the silicone blend for CS1-3 and IE1-2.

FIG. 3 is a graph illustrating surface roughness as a function of the percent by weight of MQ silicone resin in the silicone blend for CS1-3 and IE1-2.

FIG. 4 is a graph illustrating horizontal burn as a function of the percent by weight of MQ silicone resin in the silicone blend for CS1-3 and IE1-2.

FIG. 5 is a graph illustrating sweat-out as a function of the percent by weight of MQ silicone resin in the silicone blend for CS1-3 and IE1-2.

### Definitions

Any reference to the Periodic Table of Elements is that as published by CRC Press, Inc., 1990-1991. Reference to a group of elements in this table is by the new notation for numbering groups. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure and all test methods are current as of the filing date of this disclosure.

“Alkyl” and “alkyl group” refer to a saturated linear, cyclic, or branched hydrocarbon group. “Aryl group” refers to an aromatic substituent which may be a single aromatic ring or multiple aromatic rings which are fused together, linked covalently, or linked to a common group such as a methylene or ethylene moiety. The aromatic ring(s) may include phenyl, naphthyl, anthracenyl, and biphenyl, among others. In particular embodiments, aryls have between 1 and 200 carbon atoms, between 1 and 50 carbon atoms or between 1 and 20 carbon atoms.

“Alpha-olefin,” “α-olefin” and like terms refer to a hydrocarbon molecule or a substituted hydrocarbon molecule (i.e., a hydrocarbon molecule comprising one or more atoms other than hydrogen and carbon, e.g., halogen, oxygen, nitrogen, etc.), the hydrocarbon molecule comprising (i) only one ethylenic unsaturation, this unsaturation located between the first and second carbon atoms, and (ii) at least 2 carbon atoms, or 3 to 20 carbon atoms, or 4 to 10 carbon atoms, or 4 to 8 carbon atoms. Non-limiting examples of α-olefins include ethylene, propylene, 1-butene, 1-pentene, 1-hexene, 1-octene, 1-dodecene, and mixtures of two or more of these monomers.

“Blend,” “polymer blend” and like terms mean a composition of two or more polymers. Such a blend may or may not be miscible. Such a blend may or may not be phase separated.

Such a blend may or may not contain one or more domain configurations, as determined from transmission electron spectroscopy, light scattering, x-ray scattering, and any other method used to measure and/or identify domain configurations. Blends are not laminates, but one or more layers of a laminate may contain a blend.

“Carboxylate” refers to a salt or ester of carboxylic acid.

“Composition,” as used herein, includes a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step or procedure, excepting those that are not essential to operability. The term “consisting of” excludes any component, step or procedure not specifically listed. The term “or,” unless stated otherwise, refers to the listed members individually, as well as in any combination. Use of the singular includes use of the plural and vice versa.

A “conductor” is one or more wire(s), or one or more fiber(s), for conducting heat, light, and/or electricity at any voltage (DC, AC, or transient). The conductor may be a single-wire/fiber or a multi-wire/fiber and may be in strand form or in tubular form. Non-limiting examples of suitable conductors include carbon and various metals, such as silver, gold, copper, and aluminum. The conductor may also be optical fiber made from either glass or plastic. The conductor may or may not be disposed in a protective sheath. The conductor may be a single cable or a plurality of cables bound together (i.e., a cable core, or a core).

“Crosslinkable,” “curable” and like terms mean that the polymer, before or after shaped into an article, is not cured or crosslinked and has not been subjected or exposed to treatment that has induced substantial crosslinking, although the polymer comprises additive(s) or functionality which will effectuate substantial crosslinking upon subjection or exposure to such treatment (e.g., exposure to water).

“Crosslinked” and similar terms mean that the polymer composition, before or after it is shaped into an article, has xylene or decalin extractables of less than or equal to 90 weight percent (i.e., greater than or equal to 10 weight percent gel content).

“Cured” and like terms mean that the polymer, before or after it is shaped into an article, was subjected or exposed to a treatment which induced crosslinking.

An “ethylene/α-olefin polymer” is a polymer that contains a majority amount of polymerized ethylene, based on the weight of the polymer, and one or more α-olefin comonomers.

An “ethylene-based polymer,” “ethylene polymer,” or “polyethylene” is a polymer that contains equal to or greater than 50 wt %, or a majority amount of polymerized ethylene based on the weight of the polymer, and, optionally, may comprise one or more comonomers. Suitable comonomers include, but are not limited to, alpha-olefins and unsaturated esters. Suitable unsaturated esters include alkyl acyrlates, alkyl methacrylates, and vinyl carboxylates. Suitable non-limiting examples of acrylates and methacrylates include ethyl acrylate, methyl acrylate, methyl methacrylate, t-butyl acrylate, n-butyl acrylate, n-butyl methacrylate, and 2 ethylhexyl acrylate. Suitable non-limiting examples of vinyl carboxylates include vinyl acetate, vinyl propionate, and vinyl butanoate. The generic term “ethylene-based polymer” thus includes ethylene homopolymer and ethylene interpolymer. “Ethylene-based polymer” and the term “polyethylene” are used interchangeably. Non-limiting examples of ethylene-based polymer (polyethylene) include low density polyethylene (LDPE) and linear polyethylene. Non-limiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, medium density polyethylene (MDPE), and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations. Polyethylene may also be produced in a high pressure reactor without a catalyst.

“Functional group” and like terms refer to a moiety or group of atoms responsible for giving a particular compound its characteristic reactions. Non-limiting examples of functional groups include heteroatom-containing moieties, oxygen-containing moieties (e.g., alcohol, aldehyde, ester, ether, ketone, and peroxide groups), and nitrogen-containing moieties (e.g., amide, amine, azo, imide, imine, nitrate, nitrile, and nitrite groups).

“Hydrolysable silane group,” “hydrolysable silane monomer,” and like terms mean a silane group, or monomer including a silane group, that will react with water. These include alkoxysilane groups on monomers or polymers that can hydrolyze to yield silanol groups, which in turn can condense to crosslink the monomers or polymers.

“Interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

“Moisture curable” and like terms indicate that the composition will cure, i.e., crosslink, upon exposure to water. Moisture cure can be with or without the assistance of a crosslinking catalyst (e.g., a silanol condensation catalyst), promoter, etc.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. The terms “ethylene/α-olefin polymer” and “propylene/α-olefin polymer” are indicative of copolymers, as described above, prepared from polymerizing ethylene or propylene respectively, and one or more additional, polymerizable α-olefin comonomers. It is noted that although a polymer is often referred to as being “made of” one or more specified monomers, “based on” a specified monomer or monomer type, “containing” a specified monomer content, or the like. In this context, the term “monomer” is understood to be referring to the polymerized remnant of the specified monomer and not to the unpolymerized species. In general, polymers herein are referred to as being based on “units” that are the polymerized form of a corresponding monomer.

“Polyolefin” and like terms mean a polymer derived from simple olefin monomers, e.g., ethylene, propylene, 1-butene, 1-hexene, 1-octene and the like. The olefin monomers can be substituted or unsubstituted and if substituted, the substituents can vary widely.

A “propylene-based polymer,” “propylene polymer,” or “polypropylene” is a polymer that contains equal to or greater than 50 wt %, or a majority amount, of polymerized propylene based on the weight of the polymer, and, optionally, one or more comonomers. The generic term “propylene-based polymer” thus includes propylene homopolymer and propylene interpolymer.

A “sheath” is a generic term and when used in relation to cables, it includes insulation coverings or layers, jacket layers and the like.

A “wire” is a single strand of conductive metal, e.g., copper or aluminum, or optical fiber.

### Test Methods

Density is measured in accordance with ASTM D792, Method B. The result is recorded in grams (g) per cubic centimeter (g/cc or g/cm³).

The horizontal burn test is administered according to UL-2556. A burner is set at a 20° angle relative to horizontal of the sample (14 AWG copper wire with 30 mil polymer layer/wall thickness). A one-time flame is applied to the middle of the specimen for 30 seconds. The sample fails when either the cotton ignites (reported in seconds) or the char length is in excess of 100 mm.

Kinematic viscosity is the ratio of the shear viscosity to the density of a fluid and is reported in St (stokes) or cSt (centistokes). For purposes of this specification, kinematic viscosity is measured at 40° C. using a Brookfield viscometer in accordance with ASTM D445.

Melt index (MI) measurement for polyethylene is performed according to ASTM D1238, Condition 190° C./2.16 kilogram (kg) weight, formerly known as “Condition E” and also known as I₂, and is reported in grams eluted per 10 minutes.

“Room temperature” means 25° C.+/−4° C.

Surface silicone fluid extraction determination (extraction of surface silicone) is done on the compounded sample of a crosslinkable composition as disclosed herein but without having the silanol condensation catalyst. The compounded sample is melt compressed into a plaque with dimensions of 18×10×0.74 mm³ and stored at room temperature (23° C.) for 3 days before solvent extraction. The extraction is done in isopropanol (IPA) at a ratio of 1:9 w/w for 30 minutes. After the extraction step, the isopropanol phase is isolated from the sample and saved for gel permeation chromatography (GPC) or liquid chromatography (LC) analysis to quantify the amount of silicone that is extracted from the compressed sample surface into the IPA. THF (tetrahydrofuran) GPC with UV detection is used to quantify Dow Corning 3037 silicone. An agilent PLgel column (300 nm×7.5 mm I.D., pore size labeled as 100 Å) is used for GPC separation. A non-silicone fluid containing control sample is used for background subtraction of UV signal. The quantification of Dow Corning 3037 silicone is done by using the UV signal from extracted samples and a calibration curve generated from known injection concentrations of Dow Corning 3037 silicone. LC analysis with QTOF detector using an Agilent Eclipese Plus C8 1.8 um 3.0×100 mm column and a mobile phase gradient from 80% 10 mM ammonium format in H₂O and 20% 50:50 IPA:acetonitrile (ACN) to 100% IPA:ACN is used for PMX-0156 silicone quantification and PMX-200 silicone quantification. The quantifications of PMX-0156 silicone and PMX-200 silicone are done by using the MS signal from extracted samples and calibration curves generated from known injection concentration of PMX-0156 and PMX-200. The silicone fluid extraction is calculated as the extracted silicone mass per gram of sample.

Specific gravity is the ratio of the density of a substance to the density of a standard. In the case of a liquid, the standard is water. Specific gravity is a dimensionless quantity and is measured in accordance with ASTM D1298.

Surface roughness (Ra) is measured by Mitutoyo SJ 400 Surface Roughness Tester. A coated conductor wire sample is placed on the sample holder and four measurements are done on one test specimen with 90 degrees apart. Ra, the arithmetical mean roughness value, is the arithmetical mean of the absolute values of the profile deviations (z i) from the mean line of the roughness profile and is reported as determined by EN ISO 4287 and reported in μin.

Tensile elongation is measured on a jacket layer stripped from a conductor in accordance with ASTM D638 and reported in percent (%). Tensile strength is measured on a jacket layer stripped from a conductor in accordance with ASTM D638 and reported in psi.

The weight average molecular weight (Mw) is defined as weight average molecular weight of polymer, and the number average molecular weight (Mn) is defined as number average molecular weight of polymer. The polydispersity index is measured according to the following technique: The polymers are analyzed by gel permeation chromatography (GPC) on a Waters 150° C. high temperature chromatographic unit equipped with three linear mixed bed columns (Polymer Laboratories (10 micron particle size)), operating at a system temperature of 140° C. The solvent is 1,2,4-trichlorobenzene from which about 0.5% by weight solutions of the samples are prepared for injection. The flow rate is 1.0 milliliter/minute (mm/min) and the injection size is 100 microliters (μL). The molecular weight determination is deduced by using narrow molecular weight distribution polystyrene standards (Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, (621) 1968, incorporated herein by reference) to derive the equation: Mpolyethylene=(a)(Mpolystyrene)^{b}, wherein a=0.4316 and b=1.0.

Weight average molecular weight, Mw, is calculated in the usual manner according to the formula: Mw=Σ(wᵢ)(Mᵢ), wherein wi and Mi are the weight fraction and molecular weight respectively of the ith fraction eluting from the GPC column. Generally the Mw of the ethylene polymer ranges from 42,000 Da to 64,000 Da, preferably 44,000 Da, to 61,000 Da, and more preferably 46,000 Da to 55,000 Da.

### DETAILED DESCRIPTION

In an embodiment, the disclosure provides a crosslinkable composition for use as a jacket layer for a coated conductor. As used herein, “jacket layer” encompasses insulation layer. In an embodiment, the jacket layer is an insulation layer.

In an embodiment, the disclosure provides a crosslinkable composition for a jacket layer for a coated conductor, the crosslinkable composition comprising (A) a silane-functionalized polyolefin, (B) a flame retardant, (C) a silicone blend comprising (i) an MQ silicone resin, and (ii) a silicone other an the MQ silicone resin, (D) optionally, an antioxidant, and (E) a silanol condensation catalyst.

In an embodiment, the disclosure provides a jacket layer for a coated conductor comprising (A) a crosslinked silane-functionalized polyolefin, (B) a flame retardant, (C) a silicone blend comprising (i) an MQ silicone resin, and (ii) a silicone other than an MQ silicone resin, (D) optionally, an antioxidant, and (E) from 0.000 wt % to 10 wt % of a silanol condensation catalyst, based on the total weight of the jacket layer.

In an embodiment, the disclosure provides a coated conductor comprising a conductor and a coating on the conductor, the coating comprising (A) a crosslinked silane-functionalized polyolefin, (B) a flame retardant, (C) a silicone blend comprising (i) an MQ silicone resin, and (ii) a silicone other than an MQ silicone resin, (D) optionally, an antioxidant, and (E) from 0.000 wt % to 10 wt % of a silanol condensation catalyst, based on the total weight of the coating.

### Silane-Functionalized Polyolefin

The crosslinkable composition includes a silane-functionalized polyolefin. In an embodiment, the silane-functionalized polyolefin contains from 0.1 wt %, or 0.3 wt %, or 0.5 wt %, or 0.8 wt %, or 1.0 wt %, or 1.2 wt %, or 1.5 wt % to 1.8 wt %, or 2.0 wt %, or 2.3 wt %, or 2.5 wt %, or 3.0 wt %, or 3.5 wt %, or 4.0 wt %, or 4.5 wt %, or 5.0 wt % silane, based on the total weight of the silane-functionalized polyolefin.

In an embodiment, the silane-functionalized polyolefin is an alpha-olefin/silane copolymer or a silane-grafted polyolefin (Si-g-PO).

An alpha-olefin/silane copolymer is formed by the copolymerization of an alpha-olefin (such as ethylene) and a hydrolysable silane monomer (such as a vinyl silane monomer). In an embodiment, the alpha-olefin/silane copolymer in an ethylene/silane copolymer prepared by the copolymerization of ethylene, a hydrolysable silane monomer and, optionally, an unsaturated ester. The preparation of ethylene/silane copolymers is described, for example, in U.S. Pat. Nos. 3,225,018 and 4,574,133, each incorporated herein by reference.

A silane-grafted polyolefin (Si-g-PO) is formed by grafting a hydrolysable silane monomer (such as a vinyl silane monomer) onto the backbone of a base polyolefin (such as polyethylene). In an embodiment, grafting takes place in the presence of a free-radical generator, such as a peroxide. The hydrolysable silane monomer can be grafted to the backbone of the base polyolefin prior to incorporating or compounding the Si-g-PO into a final article or simultaneously with the extrusion of composition to form a final article. For example, in an embodiment, the Si-g-PO is formed before the Si-g-PO is compounded with (B) a flame retardant, (C) a silicone blend comprising (i) an MQ silicone resin, and (ii) a silicone other than an MQ silicone resin, (D) optionally, an antioxidant, (E) a silanol condensation catalyst, and other optional components. In another embodiment, the Si-g-PO is formed by compounding a polyolefin, hydrolysable silane monomer and drafting catalyst/co-agent along with (B) a flame retardant, (C) a silicone blend comprising (i) an MQ silicone resin, and (ii) a silicone other than an MQ silicone resin, (D) optionally, an antioxidant, (E) a silanol condensation catalyst, and other optional components.

The base polyolefin for a Si-g-PO may be an ethylene-based or propylene-based polymer. In an embodiment, the base polyolefin is an ethylene-based polymer, resulting in a silane-grafted ethylene-based polymer (Si-g-PE). Non-limiting examples of suitable ethylene-based polymers include ethylene homopolymers and ethylene interpolymers containing one or more polymerizable comonomers, such as an unsaturated ester and/or an alpha-olefin.

Non-limiting examples of suitable unsaturated esters used to make an alpha-olefin/silane copolymer include alkyl acrylate, alkyl methacrylate, or vinyl carboxylate. Non-limiting examples of suitable alkyl groups include methyl, ethyl, n-propyl, i-propyl, n-butyl, t-butyl, etc. In an embodiment, the alkyl group has from 1, or 2 to 4, or 8 carbon atoms. Non-limiting examples of suitable alkyl acrylates include ethyl acrylate, methyl acrylate, t-butyl acrylate, n-butyl acrylate, and 2-ethylhexyl acrylate. Non-limiting examples of suitable alkyl methacrylates include methyl methacrylate and n-butyl methacrylate. In an embodiment, the carboxylate group has from 2 to 5, or 6, or 8 carbon atoms. Non-limiting examples of suitable vinyl carboxylates include vinyl acetate, vinyl propionate, and vinyl butanoate.

In an embodiment, the silane-functionalized polyolefin is a silane-functionalized polyethylene. A “silane-functionalized polyethylene” is a polymer that contains silane and equal to or greater than 50 wt %, or a majority amount, of polymerized ethylene, based on the total weight of the polymer.

In an embodiment, the silane-functionalized polyethylene contains (i) from 50 wt %, or 55 wt %, or 60 wt %, or 65 wt %, or 70 wt %, or 80 wt %, or 90 wt %, or 95 wt % to 97 wt %, or 98 wt %, or 99 wt %, or less than 100 wt % ethylene, and (ii) from 0.1 wt %, or 0.3 wt % or 0.5 wt %, or 0.8 wt %, or 1.0 wt %, or 1.2 wt %, or 1.5 wt % to 1.8 wt %, or 2.0 wt %, or 2.3 wt %, or 2.5 wt %, or 3.0 wt %, or 3.5 wt %, or 4.0 wt %, or 4.5 wt %, or 5.0 wt % silane, based on the total weight of the silane-functionalized polyethylene.

In an embodiment, the silane-functionalized polyethylene has a density from 0.850 g/cc, or 0.860 g/cc, or 0.875 g/cc, or 0.890 g/cc to 0.900 g/cc, or 0.910 g/cc, or 0.915 g/cc, or 0.920 g/cc, or 0.930 g/cc, or 0.940 g/cc, or 0.950 g/cc or 0.960 g/cc, or 0.965 g/cc, as measured by ASTM D792.

In an embodiment, the silane-functionalized polyethylene has a melt index (MI) from 0.1 g/10 min, or 0.5 g/10 min, or 1.0 g/10 min, or 2 g/10 min, or 3 g/10 min, or 5 g/10 min, or 8 g/10 min, or 10 g/10 min, or 15 g/10 min, or 20 g/10 min, or 25 g/10 min, or 30 g/10 min to 40 g/10 min, or 45 g/10 min, or 50 g/10 min, or 55 g/10 min, or 60 g/10 min, or 65 g/10 min, or 70 g/10 min, or 75 g/10 min, or 80 g/10 min, or 85 g/10 min, or 90 g/10 min, measured in accordance with ASTM D1238 (190° C./2.16 kg).

In an embodiment, the silane-functionalized polyethylene is an ethylene/silane copolymer, comprising units derived from ethylene, units derived from a hydrolysable silane monomer, and, optionally units derived from one or more of a C₃, or C₄ to C₆, or C₈, or C₁₀, or C₁₂, or C₁₆, or C₁₈, or C₂₀ α-olefin and an unsaturated ester. In an embodiment, the ethylene/silane copolymer contains ethylene and the hydrolysable silane monomer as the only monomeric units.

Non-limiting examples of suitable ethylene/silane copolymers include SI-LINK™ DFDA-5451 NT and SI-LINK™ AC DFDB-5451 NT, each available from The Dow Chemical Company, Midland, Mich.

In an embodiment, the silane-functionalized polyethylene is a Si-g-PE. The base ethylene-based polymer for the Si-g-PE includes from 50 wt %, or 55 wt %, or 60 wt %, or 65 wt %, or 70 wt %, or 80 wt %, or 90 wt %, or 95 wt % to 97 wt %, or 98 wt %, or 99 wt %, or 100 wt % ethylene, based on the total weight of the base ethylene-based polymer.

In an embodiment, the base ethylene-based polymer for the Si-g-PE has a density from 0.850 g/cc, or 0.860 g/cc, or 0.875 g/cc, or 0.890 g/cc to 0.900 g/cc, or 0.910 g/cc, or 0.915 g/cc, or 0.920 g/cc, or 0.930 g/cc, or 0.940 g/cc, or 0.950 g/cc or 0.960 g/cc, or 0.965 g/cc, as measured by ASTM D792.

In an embodiment, the base ethylene-based polymer for the Si-g-PE has a melt index (MI) from 0.1 g/10 min, or 0.5 g/10 min, or 1.0 g/10 min, or 2 g/10 min, or 3 g/10 min, or 5 g/10 min, or 8 g/10 min, or 10 g/10 min, or 15 g/10 min, or 20 g/10 min, or 25 g/10 min, or 30 g/10 min to 40 g/10 min, or 45 g/10 min, or 50 g/10 min, or 55 g/10 min, or 60 g/10 min, or 65 g/10 min, or 70 g/10 min, or 75 g/10 min, or 80 g/10 min, or 85 g/10 min, or 90 g/10 min, measured in accordance with ASTM D1238 (190° C./2.16 kg).

In an embodiment, the base ethylene-based polymer for the Si-g-PE is a homogeneous polymer. Homogeneous ethylene-based polymers have a polydispersity index (Mw/Mn or MWD) in the range of 1.5 to 3.5 and an essentially uniform comonomer distribution, and are characterized by a single and relatively low melting point as measured by a differential scanning calorimetry (DSC). Substantially linear ethylene copolymers (SLEP) are homogeneous ethylene-based polymers. SLEPs and their method of preparation are more fully described in U.S. Pat. Nos. 5,741,858 and 5,986,028. As here used, “substantially linear” means that the bulk polymer is substituted, on average, with from about 0.01 long-chain branches/1000 total carbons (including both backbone and branch carbons), or about 0.05 long-chain branches/1000 total carbons (including both backbone and branch carbons), or about 0.3 long-chain branches/1000 total carbons (including both backbone and branch carbons) to about 1 long-chain branch/1000 total carbons (including both backbone and branch carbons), or about 3 long-chain branches/1000 total carbons (including both backbone and branch carbons).

“Long-chain branches” or “long-chain branching” (LCB) means a chain length of at least one (1) carbon less than the number of carbons in the comonomer. For example, an ethylene/1-octene SLEP has backbones with long chain branches of at least seven (7) carbons in length and an ethylene/l-hexene SLEP has long chain branches of at least five (5) carbons in length. LCB can be identified by using 13C nuclear magnetic resonance (NMR) spectroscopy and to a limited extent, e.g., for ethylene homopolymers, it can be quantified using the method of Randall (Rev. Macromol. Chem. Phys., C29 (2&3). p. 285-297). U.S. Pat. No. 4,500,648 teaches that LCB frequency can be represented by the equation LCB=b/Mw in which b is the weight average number of LCB per molecule and Mw is the weight average molecular weight. The molecular weight averages and the LCB characteristics are determined by gel permeation chromatography (GPC) and intrinsic viscosity methods.

One measure of the SCB of an ethylene copolymer is its short chain branch distribution index (SCBDI), also known as composition distribution branch index (CDBI), which is defined as the weight percent of the polymer molecules having a comonomer content within 50 percent of the median total molar comonomer content. The SCBDI or CDBI of a polymer is readily calculated from data obtained from techniques known in the art, such as temperature rising elution fractionation (TREF) as described, for example, in Wild et al., Journal of Polymer Science, Poly. Phys. Ed., Vol. 20, p. 441 (1982), or as described in U.S. Pat. No. 4,798,081. The SCBDI or CDBI for the substantially linear ethylene polymers useful in the present invention is typically greater than about 30 percent, preferably greater than about 50 percent, more preferably greater than about 80 percent, and most preferably greater than about 90 percent.

“Polymer backbone” or just “backbone” means a discrete molecule, and “bulk polymer” or just “polymer” means the product that results from a polymerization process and for substantially linear polymers, that product may include both polymer backbones having LCB and polymer backbones without LCB. Thus a “bulk polymer” includes all backbones formed during polymerization. For substantially linear polymers, not all backbones have LCB, but a sufficient number do, such that the average LCB content of the bulk polymer positively affects the melt rheology (i.e., the melt fracture properties).

In an embodiment, the base ethylene-based polymer for the Si-g-PE is an ethylene/unsaturated ester copolymer. The unsaturated ester may be any unsaturated ester disclosed herein, such as ethyl acrylate. In an embodiment, the base ethylene-based polymer for the Si-g-PE is an ethylene/ethyl acrylate (EEA) copolymer.

In an embodiment, the base ethylene-based polymer for the Si-g-PE is an ethylene/α-olefin copolymer. The α-olefin contains from 3, or 4 to 6, or 8, or 10, or 12, or 16, or 18, or 20 carbon atoms. Non-limiting examples of suitable α-olefin include propylene, butene, hexene, and octene. In an embodiment, the ethylene-based copolymer is an ethylene/octene copolymer. When the ethylene-based copolymer is an ethylene/α-olefin copolymer, the Si-g-PO is a silane-grafted ethylene/α-olefin copolymer.

Non-limiting examples of suitable ethylene/alpha-olefin copolymers useful as the base ethylene-based polymer for the Si-g-PE include homogenously branched, linear ethylene/alpha-olefin copolymers (e.g., TAFMER™ by Mitsui Petrochemicals Company Limited and EXACT™ by Exxon Chemical Company), homogeneously branched, substantially linear ethylene/alpha-olefin polymers (e.g., AFFINITY™ plastomers and ENGAGE™ elastomers available from The Dow Chemical Company), and olefin block copolymers (OBCs) (e.g., INFUSE™ resins available from the Dow Chemical Company).

The hydrolysable silane monomer used to make an alpha-olefin/silane copolymer or a Si-g-PO is a silane-containing monomer that will effectively copolymerize with an alpha-olefin (e.g., ethylene) to form an alpha-olefin/silane copolymer (e.g., an ethylene/silane copolymer) or graft to an alpha-olefin polymer (e.g., a polyolefin) to form a Si-g-PO and thus enable crosslinking. Exemplary hydrolysable silane monomers are those having the following structure:

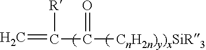

in which R′ is a hydrogen atom or methyl group; x and y are 0 or 1 with the proviso that when x is 1, y is 1; n is an integer from 1 to 12 inclusive, or 1 to 4, and each R″ independently is a hydrolysable organic group such as an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (alkylamino, arylamino), or a lower alkyl group having 1 to 6 carbon atoms inclusive, with the proviso that not more than one of the three R″ groups is an alkyl.

Non-limiting examples of suitable hydrolysable silane monomers include silanes that have an ethylenically unsaturated hydrocarbyl group, such as vinyl, allyl, isopropenyl, butenyl, cyclohexenyl or gamma-(meth)acryloxy allyl group, and a hydrolysable group, such as, for example, a hydrocarbyloxy, hydrocarbonyloxy, or hydrocarbylamino group. Examples of hydrolysable groups include methoxy, ethoxy, formyloxy, acetoxy, propionyloxy, and alkyl or arylamino groups.

In an embodiment, the hydrolysable silane monomer is an unsaturated alkoxy silane such as vinyl trimethoxy silane (VTMS), vinyl triethoxy silane, vinyl triacetoxy silane, gamma-(meth)acryloxy, propyl trimethoxy silane and mixtures of these silanes.

In an embodiment, the silane-functionalized polyolefin is a silane-grafted ethylene/C₄-C₈ alpha-olefin polymer having one or both of the following properties: (i) a density from 0.850 g/cc, or 0.860 g/cc, or 0.875 g/cc, or 0.890 g/cc to 0.900 g/cc, or 0.910 g/cc, or 0.915 g/cc, or 0.920 g/cc, or 0.925 g/cc, or 0.930 g/cc, or 0.935 g/cc; and (ii) a melt index from 0.1 g/10 min, or 0.5 g/10 min, or 1.0 g/10 min, or 2 g/10 min, or 5 g/10 min, or 8 g/10 min, or 10 g/10 min, or 15 g/10 min, or 20 g/10 min, or 25 g/10 min, or 30 g/10 min to 35 g/10 min, or 35 g/10 min, or 45 g/10 min, or 50 g/10 min, or 55 g/10 min, or 60 g/10 min, or 65 g/10 min, or 70 g/10 min, or 75 g/10 min, or 80 g/10 min, or 85 g/10 min, or 90 g/10 min; In an embodiment, the silane-grafted ethylene-based polymer has both of properties (i)-(ii).

Blends of silane-functionalized polyolefins may be used and the silane-functionalized polyolefin(s) may be diluted with one or more other polymers to the extent that the polymers are (i) miscible or compatible with one another, and (ii) the silane-functionalized polyolefin(s) constitutes from 70 wt %, or 75 wt %, or 80 wt %, or 85 wt %, or 90 wt %, or 95 wt %, or 98 wt %, or 99 wt % to less than 100 wt % of the blend.

The silane-functionalized polyolefin may comprise two or more embodiments disclosed herein.

### Flame Retardant

The crosslinkable composition includes a flame retardant. Non-limiting examples of suitable flame retardants include mineral fillers, halogenated flame retardants, halogen-free flame retardants, and combinations thereof.

In an embodiment, the flame retardant is a halogen-free flame retardant. The halogen-free flame retardant of the disclosed composition can inhibit, suppress, or delay the production of flames. Non-limiting examples of the halogen-free flame retardants for use in compositions according to this disclosure include metal hydroxides, red phosphorous, silica, alumina, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds, expanded graphite, and combinations thereof. In an embodiment, the halogen-free flame retardant can be selected from the group consisting of aluminum hydroxide, magnesium hydroxide, calcium carbonate, and combinations thereof.

The halogen-free flame retardant can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442, 7,514,489, US 2008/0251273, and WO 2013/116283. Alternatively, the acid or salt can be merely added to the composition in like amounts rather than using the surface treatment procedure. Other surface treatments known in the art may also be used including silanes, titanates, phosphates and zirconates.

In an embodiment, the flame retardant is a halogenated flame retardant. A halogenated flame retardant comprises at least one halogen atom bonded to an aromatic or cycloaliphatic ring which can be monocyclic, bicyclic or multicyclic. Functional groups in addition to the at least one halogen group may be present provided such additional functional groups do not adversely affect the processing or physical characteristics of the composition. In an embodiment, the halogenated flame retardant is a halogenated organic flame retardant. Commercially available examples of halogen-free flame retardants suitable for use in compositions according to this disclosure include, but are not limited to, APYRAL™ 40CD available from Nabaltec AG, MAGNIFIN™ H5 available from Magnifin Magnesiaprodukte GmbH & Co KG, Microcarb^{R} available from Reverte, and combinations thereof.

The flame retardant may comprise two or more embodiments disclosed herein.

### Silicone Blend

The crosslinkable composition includes a silicone blend composed of (i) an MQ silicone resin, and (ii) a silicone other than an MQ silicone resin.

The acronym MQ, as used herein, is derived from four symbols M, D, T and Q, which represent the functionality of structural units present in organosilicon compounds containing siloxane units joined by

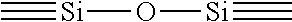

bonds. The monofunctional (M) unit represents R₃SiO_{3/2}; the dysfunctional (D) unit represents R₂SiO_{2/2}; the trifunctional (T) unit represents RSiO_{3/2} and results in the formation of branched linear siloxanes; and the tetrafunctional (Q) unit represents SiO_{4/2} which results in the formation of crosslinked and resinous compositions. R represents a monovalent organic group, preferably a hydrocarbon group such as methyl. Hence, MQ is used when the siloxane contains all monofunctional M units and tetrafunctional Q units, or from greater than or equal to 95 wt %, or 96 wt %, or 97 wt % to 98 wt %, or 99 wt %, or 100 wt % of M and Q units.

The MQ silicone resin is solid at room temperature (23° C.).

In an embodiment, the MQ silicone resin has a specific gravity from 1.00 g/cm³, or 1.05 g/cm³, or 1.10 g/cm³ to 1.15 g/cm³, or 1.20 g/cm³, or 1.25 g/cm³, or 1.30 g/cm³.

In an embodiment, the MQ silicone resin is a compound having the Structure I:

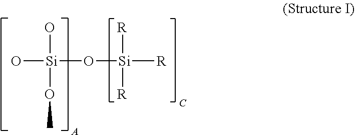

wherein A is the molar ratio of Q units and is greater than 0, C is the molar ratio of M units and is greater than 0, each R is independently selected from a hydroxy group, a monovalent hydrocarbon group, or a functionally substituted hydrocarbon group having 1 to 6 carbon atoms, and “wedge bond” or “ [symbol] ” indicates a bond to a Si in another polysiloxane chain, wherein A+B is equal to 1.00. In an embodiment, each R is a methyl group.

In an embodiment, the ratio of A:C is from 1.0:0.5 to 1.0:1.5.

In an embodiment, the MQ silicone resin is a blend of two or more silicone resins described herein.

The silicone other than an MQ silicone resin is a compound having the Structure II:

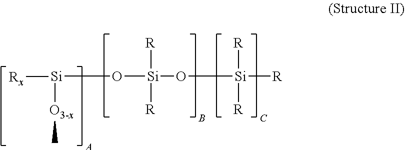

wherein x is 0 or 1, A is the molar ratio of Q units or T units and is from 100 to 115, B is the molar ratio of D units and is from 0 to 60, C is the molar ratio of M units and is from 0 to 30, each R is independently selected from an alkyl group, an aryl group, an alkoxy group, a hydroxyl group, an alkyl group or an aryl group, and “wedge bond” or “ [symbol] ” indicates a bond to a Si in another polysiloxane chain, wherein A+B+C=1.00 and with the proviso that when x=0, B≈0.

In an embodiment, the silicone other than an MQ silicone resin is a linear silicone-containing polymer or a branched silicone-containing polymer.

In an embodiment, the silicone-containing polymer is a polysiloxane. A polysiloxane is a polymer having the general Structure (III):

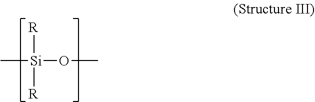

where R² and R³ are each hydrogen or an alkyl group with the proviso that, if the silicone-containing polymer is a linear polysiloxane, then both of R² and R³ must be H or a methyl group.

In an embodiment, the polysiloxane is a linear polysiloxane having the general Structure III, wherein R² and R³ are independently H or a methyl group. In an embodiment, the polysiloxane is a linear polysiloxane having the general Structure I, wherein R² and R³ are each a methyl group.

In an embodiment, the polysiloxane is a branched polysiloxane having the general structure (IV)

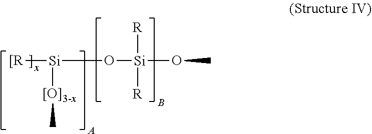

wherein x is 0 or 1, each R is independently an alkyl group or aryl group having one or more carbon atoms, A is the molar ratio of crosslinked units and is greater than 0, B is the molar ratio of linear units and is greater than 0, and A+B=1.00. In Structure IV above, each “wedge bond” or “ [symbol] ” indicates a bond to a Si in another polysiloxane chain.

In an embodiment, the A:B ratio is from 1:99, or 5:95, or 25:75 to 95:5, or 97:3, or 99:1.

In an embodiment, the branched polysiloxane is a block polysiloxane having blocks of linear units and blocks of crosslinked units or a random polysiloxane having random equilibration distributions of the crosslinked units and linear units with a natural distribution of differing structures.

In an embodiment, the silicone other than an MQ silicone resin is a reactive silicone oil or a non-reactive silicone oil. Further, in an embodiment, the silicone other than an MQ silicone resin is a polysiloxe and the polysiloxane is a reactive polysiloxane or a non-reactive polysiloxane. In an embodiment, the silicone other than an MQ silicone resin is a polysiloxane selected from a linear reactive polysiloxane, a linear non-reactive polysiloxane, a branched reactive polysiloxane or a branched non-reactive polysiloxane. A reactive polysiloxane includes at least one terminal functional group, i.e., a functional group on an end of the polymer. Non-limiting examples of suitable functional groups include groups which can go through hydrolysis and/or condensation reactions, such as hydroxysiloxy groups, trimethoxysiloxy groups, and alkoxysiloxy groups. A non-reactive polysiloxane has terminal alkyl or aromatic groups.

In an embodiment, the silicone other than an MQ silicone resin is a reactive polysiloxane having an aryl group to alkyl group ratio from 0:0, or 0.05:1, or 0.1:1, or 0.2:1, or 0.3:1, o-r 0.4:1, or 0.5:1 to 0.6:1, or 0.7:1, or 0.8:1, or 0.9:1, or 1:1. In an embodiment, the silicone other than an MQ silicone resin is a reactive polysiloxane containing only methyl and fenyl (functionalized or non-functionalized) groups. The ratio of phenyl branches to methyl branches is from 0.1:1, or 0.2:1, or 0.3:1, or 0.4:1, or 0.5:1 to 0.6:1, or 0.7:1, or 0.8:1, or 0.9:1, or 1:1.

In an embodiment, the silicone other than an MQ silicone resin is a branched reactive polysiloxane with a degree of substitution from 1.00, or 1.05, or 1.10, or 1.15, or 1.20 to 1.25, or 1.50, or 1.70, or 1.75, or 1.80, or 1.85, or 1.90, or 1.95, or 2.00.

Non-limiting examples of suitable linear polysiloxanes include linear polydimethylsiloxane (PDMS), linear poly(ethyl-methylsiloxane), and combinations thereof. A non-limiting example of a non-reactive linear polysiloxane is PMX-200, a polydimethylsiloxane polymer having terminal —Si(CH₃)₃ groups, available from Dow Corning. A non-limiting example of a reactive linear polysiloxane is XIAMETER® OHX-4000, a polydimethylsiloxane polymer having terminal silanol (e.g., —Si(CH₃)₂OH) functionality, available from Dow Corning. Non-limiting examples of suitable reactive branched polysiloxanes include Dow Corning 3037, a phenylmehtyl silane polymer fluid (0.25:1 phenyl:methyl) having unreacted methoxsilane end groups with a total methoxy content of 15-18%, available from Dow Corning.

In an embodiment, the silicone other than an MQ silicone is a mixture of two or more silicone oils as described herein.

The silicone blend has an MQ silicone:silicone other than an MQ silicone ratio from 90:10, or 80:20, or 70:30 to 30:70, or 20:80, or 10:90. In an embodiment, an MQ silicone:silicone other than the MQ silicone ratio is from 9:1, or 4:1, or 7:3, or 2:1, or 1:1 to 1:2, or 3:7, or 1:4, or 1:9.

The silicone blend may comprise two or more embodiments disclosed herein.

Antioxidant “Antioxidant” refers to types or classes of chemical compounds that are capable of being used to minimize the oxidation that can occur during the processing of polymers. Suitable antioxidants include high molecular weight hindered phenols and multifunctional phenols such as sulfur and phosphorous-containing phenol. Representative hindered phenols include; 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. In an embodiment, the composition includes pentaerythritol tetrakis(3-(3,5-di-tert-butyl-4-hydroxyphenyl)propionate), commercially available as Irganox® 1010 from BASF.

### Silanol Condensation Catalyst

In an embodiment, the crosslinkable composition includes silanol condensation catalyst, such as Lewis and Brønsted acids and bases. A “silanol condensation catalyst” promotes crosslinking of the silane-functionalized polyolefin. Lewis acids are chemical species that can accept an electron pair from a Lewis base. Lewis bases are chemical species that can donate an electron pair to a Lewis acid. Non-limiting examples of suitable Lewis acids include the tin carboxylates such as dibutyltin dilaurate (DBTDL), dimethyl hydroxy tin oleate, dioctyl tin maleate, di-n-butyl tin maleate, dibutyltin diacetate, dibutyltin dioctoate, stannous acetate, stannous octoate, and various other organo-metal compounds such as lead naphthenate, zinc caprylate and cobalt naphthenate. Non-limiting examples of suitable Lewis bases include the primary, secondary and tertiary amines. Silanol condensation catalysts are typically used in moisture cure applications.

The silanol condensation catalyst is added to the crosslinkable composition during the cable manufacturing process. As such, the silane-functionalized polyolefin may experience some crosslinking before it leaves the extruder, with the completion of the crosslinking after it has left the extruder upon exposure to humidity present in the environment in which it is stored, transported or used, although a majority of the crosslinking is delayed until exposure of the final composition to moisture (e.g., a sauna bath or a cooling bath).

In an embodiment, the silanol condensation catalyst is included in a catalyst masterbatch blend, and the catalyst masterbatch is included in the composition. The catalyst masterbatch includes the silanol condensation catalyst in one or more carrier resins. In an embodiment, the carrier resin is the same as the polyolefin resin which is functionalized with silane to become the silane-functionalized polyolefin or another polymer which is not reactive in the present composition. In an embodiment, the carrier resin is a blend of two or more such resins. Non-limiting examples of suitable carrier resins include polyolefin homopolymers (e.g., polypropylene homopolymer, polyethylene homopolymer), propylene/alpha-olefin polymers, and ethylene/alpha-olefin polymers.

Non-limiting examples of suitable catalyst masterbatch include those sold under the trade name SI-LINK™ from The Dow Chemical Company, including SI-LINK™ DFDA-5481 Natural and SI-LINK™ AC DFDA-5488 NT. SI-LINK™ DFDA-5481 Natural is a catalyst masterbatch containing a blend of 1-butene/ethene polymer, ethene homopolymer, phenolic compound antioxidant, dibutyltin dilaurate (DBTDL) (a silanol condensation catalyst), and a phenolic hydrazide compound. SI-LINK™ AC DFDA-5488 NT is a catalyst masterbatch containing a blend of a thermoplastic polymer, a phenolic compound antioxidant, and a hydrophobic acid catalyst (a silanol condensation catalyst).

In an embodiment, the silanol condensation catalyst is a blend of two or more silanol condensation catalysts as described herein.

The silanol condensation catalyst may comprise two or more embodiments disclosed herein.

### Optional Additives

In an embodiment, the crosslinkable composition includes one or more optional additives. Non-limiting examples of suitable additives include coupling agents (e.g., polar group functionalized polyolefins), metal deactivators (e.g., oxalyl bis (benzylidene) hydrazide (OABH)), moisture scavengers (e.g., alkoxy silanes), antioxidants, anti-blocking agents, stabilizing agents, colorants, ultra-violet (UV) absorbers or stabilizers (e.g., hindered amine light stabilizers (HALS) and titanium dioxide), other flame retardants, compatibilizers, fillers and processing aids.

Metal deactivators suppress the catalytic action of metal surfaces and traces of metallic minerals. Metal deactivators convert the traces of metal and metal surfaces into an inactive form, e.g., by sequestering. Non-limiting examples of suitable metal deactivators include 1,2-bis(3,5-di-tert-butyl-4-hydroxyhydrocinnamoyl)hydrazine, 2,2′-oxamindo bis[ethyl 3-(3,5-di-tert-butyl-4-hydroxyphenyl)propionate], and oxalyl bis(benzylidenehydrazide) (OABH). In an embodiment, the crosslinkable composition includes OABH.

Moisture scavengers remove or deactivate unwanted water in the crosslinkable composition to prevent unwanted (premature) crosslinking and other water-initiated reactions in the crosslinkable composition. Non-limiting examples of moisture scavengers include organic compounds selected from ortho esters, acetals, ketals or silanes such as alkoxy silanes. In an embodiment, the moisture scavenger is an alkoxy silane.

### Crosslinkable Composition

In an embodiment, the jacket layer is a reaction product of a crosslinkable composition comprising (A) a silane-functionalized polyolefin, (B) a flame retardant, (C) a silicone blend comprising (i) an MQ silicone resin, and (ii) a silicone other than an MQ silicone resin, (D) optionally, an antioxidant, and (E) a silanol condensation catalyst.

In an embodiment, the silane-functionalized polyolefin is present in an amount from 10 wt %, or 20 wt %, or 30 wt %, or 40 wt %, or 50 wt % to 60 wt %, or 70 wt %, or 80 wt %, or 90 wt %, or 95 wt %, or 99 wt % based on the total weight of the crosslinkable composition.

In an embodiment, the flame retardant comprises from greater than 0 wt %, or 10 wt %, or 20 wt %, or 30 wt %, or 40 wt % to 50 wt %, or 60 wt %, or 70 wt %, or 80 wt %, or 90 wt %, based on the total weight of the crosslinkable composition.

The silicone blend is present in an amount from greater than 0 wt %, or 1 wt %, or 2 wt %, or 3 wt %, or 4 wt %, or 5 wt % to 6 wt %, or 7 wt %, or 8 wt %, or 9 wt %, or 10 wt %, based on the total weight of the crosslinkable composition. In an embodiment, the silicone blend is present in an amount from 1.0 wt %, or 1.5 wt %, or 2.0 wt %, or 2.25 wt %, or 2.5 wt % to 2.75 wt %, or 3.0 wt %, or 3.25 wt %, or 3.5 wt %, or 4.0 wt %, or 5.0 wt %, based on the total weight of the crosslinkable composition. In an embodiment, the silicone blend, composed of (i) an MQ silicone resin, and (ii) a silicone other than an MQ silicone resin, comprises from greater than 0 wt %, or 1 wt %, or 2 wt %, or 3 wt %, or 4 wt %, or 5 wt % to 6 wt %, or 7 wt %, or 8 wt %, or 9 wt %, or 10 wt %, based on the total weight of the crosslinkable composition, with the MQ silicone:silicone other than an MQ silicone resin ratio being from 9:1, or 4:1, or 7:3, or 2:1, or 1:1 to 1:2, or 3:7, or 1:4, or 1:9.

The MQ silicone resin is present in the crosslinkable composition in an amount from greater than 0 wt %, or 1 wt %, or 2 wt %, or 3 wt %, or 4 wt %, or 5 wt % to 6 wt %, or 7 wt %, or 8 wt %, or 9 wt %, or 10 wt %, based on the total weight of the crosslinkable composition.

The silicone other than an MQ silicone resin is present in the crosslinkable composition in an amount from greater than 0 wt %, or 1 wt %, or 2 wt %, or 3 wt %, or 4 wt %, or 5 wt % to 6 wt %, or 7 wt %, or 8 wt %, or 9 wt %, or 10 wt %, based on the total weight of the crosslinkable composition.

In an embodiment, the antioxidant is present in an amount from 0 wt %, or greater than 0 wt %, or 0.01 wt %, or 0.02 wt %, or 0.03 wt %, or 0.04 wt %, or 0.05 wt %, or 0.06 wt %, or 0.07 wt %, or 0.08 wt %, or 0.09 wt %, or 0.1 wt % to 0.12 wt %, or 0.14 wt %, or 0.16 wt %, or 0.18 wt %, or 0.2 wt %, or 0.25 wt %, or 0.3 wt %, or 0.5 wt %, or 1 wt %, or 2 wt %, based on the total weight of the crosslinkable composition.

In an embodiment, the silanol condensation catalyst is present in an amount from 0.002 wt %, or 0.005 wt %, or 0.01 wt %, or 0.02 wt %, or 0.05 wt %, or 0.08 wt %, or 0.1 wt %, or 0.15 wt %, or 0.2 wt %, or 0.3 wt %, or 0.4 wt %, or 0.5 wt %, or 0.6 wt %, or 0.8 wt %, or 1.0 wt % to 1.5 wt %, or 2 wt %, or 4 wt %, or 5 wt %, or 6 wt %, or 8 wt %, or 10 wt %, or 15 wt %, or 20 wt %, based on the total weight of the crosslinkable composition. In an embodiment, the silanol condensation catalyst is provided in the form of a catalyst masterbatch and the composition contains from 0.5 wt %, or 1.0 wt %, or 2.0 wt %, or 3.0 wt %, or 4.0 wt % to 5.0 wt %, or 6.0 wt %, or 7.0 wt %, or 8.0 wt %, or 9.0 wt %, or 10.0 wt %, or 15.0 wt %, or 20.0 wt % catalyst masterbatch, based on total weight of the crosslinkable composition.

In an embodiment, a metal deactivator is present in an amount from 0 wt %, or greater than 0 wt %, or 0.01 wt %, or 0.02 wt %, or 0.03 wt %, or 0.04 wt %, or 0.05 wt %, or 0.1 wt %, or 0.5 wt %, or 1 wt %, or 2 wt %, or 3 wt % to 5 wt %, or 6 wt %, or 7 wt %, or 8 wt %, or 9 wt % or 10 wt %, based on the total weight of the crosslinkable composition.

In an embodiment, a moisture scavenger is present in an amount from 0 wt %, or greater than 0 wt %, or 0.01 wt %, or 0.02 wt %, or 0.03 wt %, or 0.04 wt %, or 0.05 wt %, or 0.1 wt %, or 0.2 wt % to 0.3 wt %, or to 0.5 wt %, or to 0.75 wt %, or to 1.0 wt %, or to 1.5 wt %, or to 2.0 wt %, or to 3.0 wt %, based on the total weight of the crosslinkable composition.

In an embodiment, one or more additives, e.g., anti-blocking agents, stabilizing agents, colorants, UV-absorbers or stabilizers, other flame retardants, compatibilizers, fillers and processing aids, are present in an amount from 0 wt %, or greater than 0 wt %, or 0.01 wt %, or 0.1 wt % to 1 wt %, or 2 wt %, or 3 wt % or 5 wt %, or 10 wt %, based on the total weight of the crosslinkable composition.

The crosslinkable composition can be prepared by dry blending or melt blending the individual components and additives. The melt blend can be pelletized for future use or immediately transferred to an extruder to form an insulation or jacket layer and/or coated conductor. For convenience, certain ingredients may be premixed, such as by melt processing or into masterbatches.

In an embodiment, the crosslinkable composition is moisture-curable.

The crosslinkable composition can comprise two or more embodiments disclosed herein.

### Jacket Layer

In an embodiment, the crosslinkable composition is used to form a jacket layer. In an embodiment, the jacket layer is an insulation layer.

The process for producing a jacket layer includes heating the crosslinkable composition to at least the melting temperature of the silane-functionalized polyolefin and then extruding the polymer melt blend onto a conductor. The term “onto” includes direct contact or indirect contact between the melt blend and the conductor. The melt blend is in an extrudable state.

The jacket layer is crosslinked. In an embodiment, the crosslinking begins in the extruder, but only to a minimal extent. In another embodiment, crosslinking is delayed until the composition is cured by exposure to moisture (“moisture curing”).

As used herein, “moisture curing” is the hydrolysis of hydrolysable groups by exposure of the silane-functionalized polyolefin to water, yielding silanol groups which then undergo condensation (with the help of the silanol condensation catalyst) to form silane linkages. The silane linkages couple, or otherwise crosslink, polymer chains to produce the silane-coupled polyolefin or silane-crosslinked polyolefin. A schematic representation of the moisture curing reaction is provided in reaction (V) below.

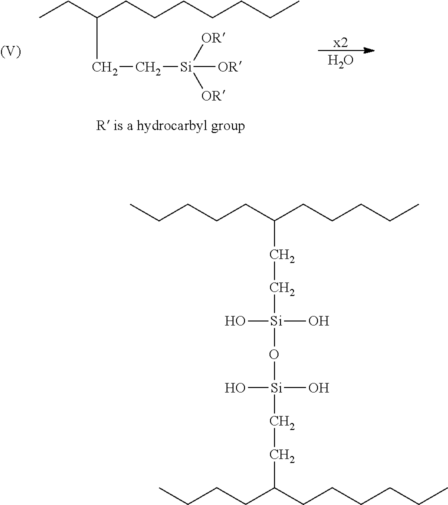

In an embodiment, the moisture is water. In an embodiment, the moisture curing is conducted by exposing the jacket layer or coated conductor to water in the form of humidity (e.g., water in the gaseous state or steam) or submerging the insulation or jacket layer or coated conductor in a water bath. Relative humidity can be as high as 100%.

In an embodiment, the moisture curing takes place at a temperature from room temperature (ambient conditions) to up to 100° C. for a duration from 1 hour, or 4 hours, or 12 hours, or 24 hours, or 3 days, or 5 days to 6 days, or 8 days, or 10 days, or 12 days, or 14 days, or 28 days, or 60 days.

In an embodiment, the disclosure provides a jacket layer for a coated conductor comprising (A) a silane-functionalized polyolefin, (B) a flame retardant, (C) a silicone blend comprising (i) an MQ silicone resin, and (ii) a silicone other than an MQ silicone resin, (D) optionally, an antioxidant, and (E) from 0.000 wt % to 20 wt % of a silanol condensation catalyst.

In an embodiment, the silane-functionalized polyolefin is present in an amount from 10 wt %, or 20 wt %, or 30 wt %, or 40 wt %, or 50 wt % to 60 wt %, or 70 wt %, or 80 wt %, or 90 wt %, or 95 wt %, or 99 wt % based on the total weight of the jacket layer.

In an embodiment, the flame retardant comprises from greater than 0 wt %, or 10 wt %, or 20 wt %, or 30 wt %, or 40 wt % to 50 wt %, or 60 wt %, or 70 wt %, or 80 wt %, or 90 wt %, based on the total weight of the jacket layer.

In an embodiment, the silicone blend, composed of (i) an MQ silicone resin, and (ii) a silicone other than an MQ silicone resin, comprises from greater than 0 wt %, or 1 wt %, or 2 wt %, or 3 wt %, or 4 wt %, or 5 wt % to 6 wt %, or 7 wt %, or 8 wt %, or 9 wt %, or 10 wt %, based on the total weight of the jacket layer, with the MQ silicone:silicone other than an MQ silicone resin ratio being from 9:1, or 4:1, or 7:3, or 2:1, or 1:1 to 1:2, or 3:7, or 1:4, or 1:9.

In an embodiment, the antioxidant is present in an amount from 0 wt %, or greater than 0 wt %, or 0.01 wt %, or 0.02 wt %, or 0.03 wt %, or 0.04 wt %, or 0.05 wt %, or 0.06 wt %, or 0.07 wt %, or 0.08 wt %, or 0.09 wt %, or 0.1 wt % to 0.12 wt %, or 0.14 wt %, or 0.16 wt %, or 0.18 wt %, or 0.2 wt %, or 0.25 wt %, or 0.3 wt %, or 0.5 wt %, or 1 wt %, or 2 wt %, based on the total weight of the jacket layer.

In an embodiment, the silanol condensation catalyst is present in an amount from 0.000 wt %, or 0.002 wt %, or 0.005 wt %, or 0.01 wt %, or 0.02 wt %, or 0.05 wt %, or 0.08 wt %, or 0.1 wt %, or 0.15 wt %, or 0.2 wt %, or 0.3 wt %, or 0.4 wt %, or 0.5 wt %, or 0.6 wt %, or 0.8 wt %, or 1.0 wt % to 1.5 wt %, or 2 wt %, or 4 wt %, or 5 wt %, or 6 wt %, or 8 wt %, or 10 wt %, or 15 wt %, or 20 wt %, based on the total weight of the jacket layer.

In an embodiment, a metal deactivator is present in an amount from 0 wt %, or greater than 0 wt %, or 0.01 wt %, or 0.02 wt %, or 0.03 wt %, or 0.04 wt %, or 0.05 wt %, or 0.1 wt %, or 0.5 wt %, or 1 wt %, or 2 wt %, or 3 wt % to 5 wt %, or 6 wt %, or 7 wt %, or 8 wt %, or 9 wt % or 10 wt %, based on the total weight of the jacket layer.

In an embodiment, a moisture scavenger is present in an amount from 0 wt %, or greater than 0 wt %, or 0.01 wt %, or 0.02 wt %, or 0.03 wt %, or 0.04 wt %, or 0.05 wt %, or 0.1 wt %, or 0.2 wt % to 0.3 wt %, or to 0.5 wt %, or to 0.75 wt %, or to 1.0 wt %, or to 1.5 wt %, or to 2.0 wt %, or to 3.0 wt %, based on the total weight of the jacket layer.

In an embodiment, one or more additives, e.g., anti-blocking agents, stabilizing agents, colorants, UV-absorbers or stabilizers, other flame retardants, compatibilizers, fillers and processing aids, is present in an amount from 0 wt %, or greater than 0 wt %, or 0.01 wt %, or 0.1 wt % to 1 wt %, or 2 wt %, or 3 wt % or 5 wt %, or 10 wt %, based on the total weight of the jacket layer.

In an embodiment, the jacket layer has a thickness from 5 mil, or from 10 mil, or from 15 mil, or from 20 mil, to 25 mil, or 30 mil, or 35 mil, or 40 mil, or 50 mil, or 75 mil, or 100 mil.

In an embodiment, the jacket layer passes the horizontal burn test as defined in Horizontal Flame UL 2556. To pass the horizontal burn test, the jacket layer must have a total char of less than 100 mm. In an embodiment, the jacket layer has a total char during the horizontal burn test from 20 mm, or 25 mm, or 30 mm to 50 mm, or 55 mm, or 60 mm, or 70 mm, or 75 mm, or 80 mm, or 90 mm, or less than 100 mm.

In an embodiment, the jacket layer has a tensile strength, as measured in accordance with ASTM D638, from greater than 1500 psi, or 1550 psi, or 1600 psi, or 1650 psi to 1700 psi, or 1750 psi, or 1800 psi, or 1850 psi, or 1900 psi, or 1950 psi.

In an embodiment, the jacket layer has a tensile elongation, as measured in accordance with ASTM D638, from greater than 200%, or 225%, or 250%, or 275% to 300%, or 325%, or 350%, or 375%, or 400%.

In an embodiment, the jacket layer has a surface roughness (extruded onto 14AWG solid copper conductor, 30 mil wall thickness of jacket layer; wire roughness Ra) from 0 μin, or >0 μin, or 10 μin, or 20 μin to ≤30 μin, or ≤40 μin, or ≤50 μin, or ≤60 μin, or ≤70 μin, or ≤80 μin, or ≤90 μin, or ≤100 μin.

In an embodiment, the jacket layer has a lower silicone fluid extraction. As set forth above, to test for silicone fluid extraction, a compounded sample of the crosslinkable composition (without silanol condensation catalyst) is prepared by melt compression. In an embodiment, the compounded sample has a silicone fluid extraction from 0 mg/g, or greater than 0 mg/g, or 0.100 mg/g, or 0.150 mg/g, or 0.200 mg/g, or 0.250 mg/g, or 0.300 mg/g to 0.350 mg/g, or 0.400 mg/g, or 0.450 mg/g, or 0.500 mg/g, or 0.550 mg/g, or 0.600 mg/g, or 0.700 mg/g, or 0.800 mg/g, or 0.900 mg/g, or less than 1.000 mg/g.

In an embodiment, the jacket layer passes the horizontal burn test and has a tensile strength, as measured in accordance with ASTM D638, from greater than 1500 psi, or 1550 psi, or 1600 psi, or 1650 psi to 1700 psi, or 1750 psi, or 1800 psi, or 1850 psi, or 1900 psi, or 1950 psi.

Jacket Layer 1: In an embodiment, the jacket layer comprises: (A) from 40 wt %, or 45 wt %, or 47 wt %, or 50 wt % to 52 wt %, or 55 wt %, or 60 wt % based on the total weight of the jacket layer, of a silane-grafted polyethylene; (B) from 40 wt %, or 42 wt %, or 44 wt %, or 46 wt %, or 48 wt % to 50 wt %, or 52 wt %, or 54 wt %, or 56 wt %, based on the total weight of the jacket layer, of a halogen-free flame retardant; (C) from 1.00 wt %, or 1.25 wt %, or 1.50 wt %, or 1.75 wt %, or 2.00 wt % to 2.25 wt %, or 2.50 wt %, or 2.75 wt %, or 3.00 wt %, or 3.25 wt %, or 3.5 wt %, based on the total weight of the jacket layer, of a silicone blend, wherein the silicone blend is composed of (i) an MQ silicone resin, and (ii) a silicone other than an MQ silicone resin at an MQ silicone:silicone other than an MQ silicone resin ratio from 0.5:1, or 1:1, or 1.5:1, or 2:1 to 1:2, or 1:1.5, or 1:1, or 1:0.5; (D) from 0.14 wt %, or 0.16 wt %, or 0.18 wt %, or 0.20 wt % to 0.22 wt %, or 0.24 wt %, or 0.26 wt %, or 0.28 wt %, or 0.30 wt %, based on the total weight of the jacket layer, of an antioxidant; and (E) from 0.00 wt %, or 0.001 wt %, or 0.002 wt %, or 0.005 wt %, or 0.01 wt %, or 0.02 wt %, or 0.05 wt %, or 0.08 wt %, or 0.1 wt %, or 0.15 wt %, or 0.2 wt %, or 0.3 wt %, or 0.4 wt %, or 0.5 wt % to 0.6 wt %, or 0.8 wt %, or 1.0 wt %, or 1.5 wt %, or 2 wt %, or 4 wt %, based on the total weight of the jacket layer, of a silanol condensation catalyst.

Jacket Layer 2: In an embodiment, the jacket layer comprises: (A) from 40 wt %, or 45 wt % to 47 wt %, or 50 wt %, or 52 wt %, based on the total weight of the jacket layer, of a silane-grafted polyethylene; (B) from 44 wt %, or 46 wt %, or 48 wt % to 50 wt %, or 52 wt %, or 54 wt %, based on the total weight of the jacket layer, of a halogen-free flame retardant; (C) from 1.50 wt %, or 1.75 wt %, or 2.00 wt % to 2.50 wt %, or 2.75 wt %, or 3.00 wt %, or 3.25 wt %, based on the total weight of the jacket layer, of a silicone blend, wherein the silicone blend is composed of (i) an MQ silicone resin, and (ii) a silicone other than an MQ silicone which is a polysiloxane at an MQ silicone:polysiloxane ratio from 0.5:1, or 1:1, or 1.5:1, or 2:1 to 1:2, or 1:1.5, or 1:1, or 1:0.5; (D) from 0.18 wt %, or 0.20 wt % to 0.22 wt %, or 0.24 wt %, or 0.26 wt %, based on the total weight of the jacket layer, of an antioxidant; and (E) from 0.00 wt %, or 0.001 wt %, or 0.002 wt %, or 0.005 wt %, or 0.01 wt %, or 0.02 wt %, or 0.05 wt %, or 0.08 wt %, or 0.1 wt %, or 0.15 wt %, or 0.2 wt %, or 0.3 wt %, or 0.4 wt %, or 0.5 wt % to 0.6 wt %, or 0.8 wt %, or 1.0 wt %, or 1.5 wt %, or 2 wt %, or 4 wt %, based on the total weight of the jacket layer, of a silanol condensation catalyst.

In an embodiment, the insulation layer is according to Jacket Layer 1 or Jacket Layer 2 having one, some, or all of the following properties: (i) passes the horizontal burn test; and/or (ii) a tensile strength, as measured in accordance with ASTM D638, from greater than 1500 psi, or 1550 psi, or 1600 psi, or 1650 psi to 1700 psi, or 1750 psi, or 1800 psi, or 1850 psi, or 1900 psi, or 1950 psi; and/or (iii) a tensile elongation, as measured in accordance with ASTM D638, from greater than 200%, or 225%, or 250%, or 275% to 300%, or 325%, or 350%, or 375%, or 400%; and/or (iv) a surface roughness from 0 μin, or >0 μin, or 10 μin, or 20 μm to ≤30 μm, or ≤40 μin, or ≤50 μm, or ≤60 μin, or ≤70 μm, or ≤80 μin, or ≤90 μin, or ≤100 μm. In an embodiment, the insulation or jacket layer has at least 2, at least 3, or all 4 of properties (i)-(iv).

In an embodiment, the jacket layer is according to Jacket Layer 1 or Jacket Layer 2, wherein the silicone other than an MQ silicone resin is a reactive branched polysiloxane, and wherein the jacket layer has one, some, or all of the following properties: (i) passes the horizontal burn test; and/or (ii) a tensile strength, as measured in accordance with ASTM D638, from greater than 1700 psi, or 1725 psi, or 1750 psi, or 1775 psi to 1800 psi, or 1825 psi, or 1850 psi; and/or (iii) a tensile elongation, as measured in accordance with ASTM D638, from greater than 200%, or 225%, or 250%, or 275% to 300%, or 325%, or 350%, or 375%, or 400%; and/or (iv) a surface roughness from 0 μin, or >0 μin, or 5 μin, or 10 μin, or 20 μm, to ≤25 μin, or ≤30 μin, or ≤35 μin, or ≤40 μin, or ≤45 μin, or ≤50 μin. In an embodiment, the jacket layer has at least 2, at least 3, or all 4 of properties (i)-(iv).

The jacket layer may comprise two or more embodiments disclosed herein.

### Coated Conductor

In an embodiment, the disclosure provides a coated conductor comprising a coating on the conductor, the coating comprising (A) a silane-functionalized polyolefin, (B) a flame retardant, (C) a silicone blend comprising (i) an MQ silicone resin, and (ii) a silicone other than an MQ silicone resin, (D) optionally, an antioxidant, and (E) from 0.000 wt % to 20 wt % of a silanol condensation catalyst. In an embodiment, the coating on the coated conductor is a jacket layer in accordance with any embodiment or combination of embodiments disclosed herein.

The coating may be one or more inner layers. The coating may wholly or partially cover or otherwise surround or encase the conductor. The coating may be the sole component surrounding the conductor. Alternatively, the coating may be one layer of a multilayer jacket or sheath encasing the conductor. In an embodiment, the coating directly contacts the conductor. In another embodiment, the coating directly contacts an intermediate layer surrounding the conductor.

In an embodiment, the coating has a thickness from 5 mil, or from 10 mil, or from 15 mil, or from 20 mil, to 25 mil, or 30 mil, or 35 mil, or 40 mil, or 50 mil, or 75 mil, or 100 mil.

In an embodiment, the coated conductor passes the horizontal burn test. To pass the horizontal burn test, the coating must have a total char of less than 100 mm. In an embodiment, the coated conductor has a total char during the horizontal burn test from 0 mm, or 5 mm, or 10 mm to 50 mm, or 55 mm, or 60 mm, or 70 mm, or 75 mm, or 80 mm, or 90 mm, or less than 100 mm.

In an embodiment, the coating on the coated conductor is according to Jacket Layer 1 or Jacket Layer 2, wherein the coated conductor has one, some, or all of the following properties: (i) the coated conductor passes the horizontal burn test; and/or (ii) the coating has a tensile strength, as measured in accordance with ASTM D638, from greater than 1500 psi, or 1550 psi, or 1600 psi, or 1650 psi to 1700 psi, or 1750 psi, or 1800 psi, or 1850 psi, or 1900 psi, or 1950 psi; and/or (iii) the coating has a tensile elongation, as measured in accordance with ASTM D638, from greater than 200%, or 225%, or 250%, or 275% to 300%, or 325%, or 350%, or 375%, or 400%; and/or (iv) the coating has a surface roughness from 0 μin, or >0 μin, or 10 μin, or 20 μin to ≤30 μin, or ≤40 μin, or ≤50 μin, or ≤60 μin, or ≤70 μin, or ≤80 μin, or ≤90 μin, or ≤100 μin. In an embodiment, the coated conductor has at least 2, at least 3, or all 4 of properties (i)-(iv).

In an embodiment, the coating on the coated conductor is according to Jacket Layer 1 or Jacket Layer 2, wherein the silicone other than an MQ silicone resin is a reactive branched polysiloxane and the coated conductor has one, some, or all of the following properties: (i) the coated conductor passes the horizontal burn test; and/or (ii) the coating has a tensile strength, as measured in accordance with ASTM D638, from greater than 1700 psi, or 1725 psi, or 1750 psi, or 1775 psi to 1800 psi, or 1825 psi, or 1850 psi; and/or (iii) the coating has a tensile elongation, as measured in accordance with ASTM D638, from greater than 200%, or 225%, or 250%, or 275% to 300%, or 325%, or 350%, or 375%, or 400%; and/or (iv) the coating has a surface roughness from 0 μin, or >0 μin, or 5 μin, or 10 μin, or 20 μin to ≤25 μin, or ≤30 μin, or ≤35 μin, or ≤40 μin, or ≤45 μin, or ≤50 μin. In an embodiment, the coated conductor has at least 2, at least 3, or all 4 of properties (i)-(iv).

In an embodiment, the coating is a jacket layer. In an embodiment, the jacket layer is an insulation layer. The coated conductor may comprise two or more embodiments disclosed herein.

By way of example, and not limitation, some embodiments of the present disclosure will now be described in detail in the following Examples.

### Examples

### Materials

TABLE 1
Materials

| Component | Specification | Source |
|---|---|---|
| ENGAGE 8402 | ethylene-octene copolymer having a density of | Dow Chemical |
| | 0.902 g/cc and a MI of 30 g/10 min. | Company |
| VTMS | vinyltrimethoxysilane having a density of 0.968 g/mL | Dow-Corning |
| | at 25° C. and a boiling point 123° C. | |
| Luperox 101 | 2,5-bis(tert-butylperoxy)-2,5-dimethylhexane grafting initiator | Sigma-Aldrich |
| HFFR Mineral Filler | Microcarb 95T is ultramicronized and treated calcium carbonate | Reverte |
| AO | Irganox 1010 (antioxidant) | Sigma-Aldrich |
| MQ1 | a 100% trimethylsiloxysilicate solid resin | Dow-Corning |
| MQ2 | TMS-803, a co-hydrolysis product of | Wacker Chemical |
| | tetraalkoxysilane and trimethylethoxysilane | Corporation |
| Silicone Other | Dow Corning 3037, a reactive branched polysiloxane (phenyl | Dow-Corning |
| Than the MQ | methyl silicone polymer fluid) with unreacted terminal | |
| Silicone Resin | methoxysilane gropus, a phenyl:methyl branch ratio of 0.25:1, a | |
| 1 (Silicone 1) | methoxy content of 15-18%, a weight average molecular weight of | |
| | 700-1500 Daltons, a specific gravity at 25° C. of 1.07, a kinematic | |
| | viscosity at 25° C. of 8-20 cSt and a degree of substitution of 1.7 | |
| Silicone Other | XIAMETER® PMX-200 (350 cSt), a non-reactive linear | Dow-Corning |
| Than the MQ | polydimethylsiloxane (dimethyl siloxane, trimethylsiloxy- | |
| Silicone Resin | terminated) with a specific gravity of 0.978 at 25° C. and a | |
| 2 (Silicone 2) | kinematic viscosity of 350 Centistokes. | |
| Silicone Other | XIAMETER® PMX-0156, a reactive linear polysiloxane with a | Dow-Corning |
| Than the MQ | kinematic viscosity at 25° C. of 50-120 cSt. | |
| Silicone Resin | | |
| 3 (Silicone 3) | | |
| Amplify™ TY 1057 | coupling agent, a maliec anhydride-grafted linear | The Dow |
| | low density polyethylene having a density of | Chemical |
| | 0.912 g/cc and a melt index of 3.0 g/10 min | Company |
| oxalyl bis (benzylidene) | metal deactivator (MD) | FutureFuel Corp. |
| hydroxide | | |
| Prosil 9202 | scorch retardant, triethoxy(octyl)silane | Milliken Chemical |
| ENGAGE 8450 | ethylene/octene copolymer having a density of | The Dow |
| | 0.902 g/cc and a MI of 3.0 g/10 min | Chemical |
| | | Company |
| DFH-2065 | linear low density polyethylene, | The Dow |
| | having a melt index of 0.65 grams/10 | Chemical |
| | minutes and a density of 0.920 g/cc | Company |
| DXM 446 or | low density polyethylene having a melt index of | The Dow |
| DFDA-1216 | 2.35 g/10 minutes and a density of 0.92 g/cc | Chemical |
| | | Company |
| Dibutyltin dilaurate | silanol condensation catalyst | Sigma-Aldrich |
| 1,2-bis(3,5-di-tert-butyl-4- | antioxidant | Sigma-Aldrich |
| hydroxyhydrocinnamoyl) | | |
| hydrazine | | |
| Tetrakis(methylene | antioxidant | Sigma-Aldrich |
| (3,5-di-tert-butyl-4- | | |
| hydroxyhydrocinnamate)) | | |
| methane | | |

### Sample Preparation

A silane-grafted polyethylene is prepared by reactive extrusion through a twin-screw extruder. 1.8 wt %, based on the total weight of base resin (ENGAGE 8402), of vinyltrimethoxysilane (VTMS) and 900 ppm based on the total weight of the base resin (ENGAGE 8402) of Luperox 101 are weighed and mixed together followed by approximately 10 to 15 minutes of magnetic stirring to achieve a uniform liquid mixture. The mixture is placed on a scale and connected to a liquid pump injection. ENGAGE 8402 is fed into the main feeder of the ZSK-30 extruder. The barrel temperature profile of the ZSK-30 is set as follows:

| | |
|---|---|
| 2-3 | 160° C. |
| 4-5 | 195° C. |
| 6-7 | 225° C. |
| 8-9 | 225° C. |
| 10-11 | 170° C. |

The pellet water temperature is as near to 10° C. (50° F.) as possible and a chiller water temperature is as near to 4° C. (40° C.) as possible.

The amount of VTMS grafted to the polyethylene is determined by infrared spectroscopy. Spectra are measured with a Nicolet 6700 FTIR instrument. The absolute value is measured by FTIR mode without the interference from surface contamination. The ratio of the absorbances at 1192 cm⁻¹ and 2019 cm⁻¹ (internal thicknesses) is determined. The ratio of the 1192/2019 peak heights is compared to standards with known levels of VTMS in DFDA-5451 (available as SI-LINK 5451 from the Dow Chemical Company). Results show that the grafted VTMS content of the silane-grafted polyethylene (Si-g-PE) is about 1.7 mass % based on the total mass of the polymer.

The Si-g-PE is added into a Brabender at around 140° C. and the flame retardant, MQ silicone resin, silicone other than the MQ silicone resin, metal deactivator, scorch retardant, and the antioxidant Irganox 1010 are added into the bowl after the Si-g-PE is melted in amounts as specified in Table 3 below. The mixture is mixed for about 5 minutes.

The resulting crosslinkable composition (without silanol condensation catalyst) is then pelletized into small pieces for wire extrusion. In the extrusion step, the silanol condensation catalyst, in the form of a masterbatch as set forth in Table 2, below, is added with the pelletized mixture to extrude the wire on 14 AWG copper wire of 0.064 in diameter. The wall thickness is set around 30 mil and the extrusion temperature is from 140° C. to a head temperature of 165° C. The concentration of silanol condensation catalyst in the overall composition is in the range of 0.01 wt % to 0.5 wt %. The extruded wires are cured in a 90° C. water bath overnight. The cured wires are cut into 15 feet (4.572 meter) long segments and placed in an electrical bath at 90° C.

TABLE 2
Catalyst Masterbatch (“MB”)

| | |
|---|---|
| ENGAGE 8450 | 80.00 wt % |
| DFH-2065 LLDPE | 17.14 wt % |
| DFDA-1216 NT | 1.34 wt % |
| 1,2-bis(3,5-di-tert-buty1-4- | 0.33 wt % |
| hydroxyhydrocinnamoyl)hydrazine | |
| Tetrakis(methylene (3,5-di-tert-butyl-4- | 0.67 wt % |
| hydroxyhydrocinnamate))methane | |
| Dibutyltin dilaurate | 0.52 wt % |
| Total: | 100.00 wt % |

The horizontal burn test is applied to the extruded wires according to UL-2556. A burner is set at a 20° angle relative to horizontal of the sample (14 AWG copper wire with 30 mil wall thickness). A one-time flame is applied to the middle of the specimen for 30 seconds. The sample fails when either the cotton ignites (reported in seconds) or the samples char in excess of 100 mm (UL 1581, 1100.4). Tensile tests are applied to the extruded wires according to ASTM D638. Wire smoothness is calculated as the roughness average (Ra).

TABLE 3
Comparative and Inventive Examples

| | Component | | | | | | | | | | | |
|---|---|---|---|---|---|---|---|---|---|---|---|---|
| | (wt %) | CS1 | CS2 | CS3 | CS4 | CS5 | CS6 | IE1 | IE2 | IE3 | IE4 | IE5 |
| Component A | Si-g-PE | 45.63 | 44.76 | 44.76 | 44.76 | 44.76 | 44.76 | 44.76 | 44.76 | 44.76 | 44.76 | 44.76 |
| Component B | HFFR | 49.48 | 48.00 | 48.00 | 48.00 | 48.00 | 48.00 | 48.00 | 48.00 | 48.00 | 48.00 | 48.00 |
| | Mineral | | | | | | | | | | | |
| | Filler | | | | | | | | | | | |
| Component C(i) | MQ1 | — | — | 3.00 | — | — | — | 1.50 | 2.00 | 1.50 | 1.50 | — |
| | MQ2 | — | — | — | — | — | 3.00 | — | — | — | — | 1.50 |
| Component C(ii) | Silicone 1 | — | 3.00 | — | — | — | — | 1.50 | 1.00 | — | — | 1.50 |
| | Silicone 2 | — | — | — | 3.00 | — | — | — | — | 1.50 | — | — |
| | Silicone 3 | — | — | — | — | 3.00 | — | — | — | — | 1.50 | — |
| Component D | AO | 0.21 | 0.20 | 0.20 | 0.20 | 0.20 | 0.20 | 0.20 | 0.20 | 0.20 | 0.20 | 0.20 |
| Additives | Coupling | 4.12 | 4.00 | 4.00 | 4.00 | 4.00 | 4.00 | 4.00 | 4.00 | 4.00 | 4.00 | 4.00 |
| | Agent | | | | | | | | | | | |
| | Metal | 0.04 | 0.04 | 0.04 | 0.04 | 0.04 | 0.04 | 0.04 | 0.04 | 0.04 | 0.04 | 0.04 |
| | Deactivator | | | | | | | | | | | |
| | Scorch | 0.52 | — | — | — | — | — | — | — | — | — | — |
| | Retardant | | | | | | | | | | | |
| Total Before | | 100.00 | 100 | 100 | 100 | 100 | 100 | 100 | 100 | 100 | 100 | 100 |
| Extrusion | | | | | | | | | | | | |
| | Catalyst | 3.00 | 3.00 | 3.00 | 3.00 | 3.00 | 3.00 | 3.00 | 3.00 | 3.00 | 3.00 | 3.00 |
| | Masterbatch | | | | | | | | | | | |
| | (Table 2) | | | | | | | | | | | |
| Total After | | 103 | 103 | 103 | 103 | 103 | 103 | 103 | 103 | 103 | 103 | 103 |
| Extrusion | | | | | | | | | | | | |

| | | | | | | | | | | | |
|---|---|---|---|---|---|---|---|---|---|---|---|
| Tensile Strength (psi) | 1927 | 1804 | 1458.5 | NA | NA | 1457 | 1820 | 1788 | 1587 | 1688 | 1749 |
| Tensile Elongation (%) | 260 | 335.5 | 167.5 | NA | NA | 199 | 259 | 283 | 247 | 279 | 315 |
| Mini Wire Line Extruded | 14 | 20 | 287 | NA | NA | 446 | 26 | 46 | 98 | 77 | 23 |
| 14AWG 30 mil Wire | | | | | | | | | | | |
| Roughness Ra (μin) | | | | | | | | | | | |
| Horizontal Burn | 102 | 33 | 54 | NA | NA | 56 | 35 | 50 | 43 | 40 | 45 |
| (char length, mm) | | | | | | | | | | | |
| Silicone Fluid | — | 1.508 | 0.000 | NA | NA | 0.000 | 0.272 | 0.315 | 0.360 | <0.010 | 0.421 |
| Extraction** (mg/g) | | | | | | | | | | | |

CS = comparative sample
IE = inventive example
*NA = unable to extrude sample
**tested prior to addition of catalyst masterbatch

The examples show that the combination of an MQ silicone resin with a silicone other than an MQ silicone resin unexpectedly results in a composition which passes the horizontal burn test and has a synergistic balance of acceptable tensile properties, low surface roughness, and low silicone fluid extraction. Inventive Examples 1-5 each pass the horizontal burn test and meet minimum threshold requirements for tensile strength (i.e., tensile strength greater than 1500 psi), tensile elongation (i.e., tensile elongation greater than 200%), roughness (i.e., Ra less than 100 μin) and silicone fluid extraction (less than 1.000 mg/g).

In comparison, Comparative Sample 1, containing no silicone, i.e., no MQ silicone resin and no silicone other than an MQ silicone resin, fails the horizontal burn test (char length of 102 mm). The inclusion of an MQ silicone resin alone (i.e., no silicone other than an MQ silicone resin), as in Comparative Samples 3 and 6, improves burn performance but at the detriment of the tensile properties. The inclusion of a silicone other than an MQ silicone resin alone (i.e., no MQ silicone resin) results in compositions (prior to the addition of silanol condensation catalyst) which either are not suitable for extrusion (Comparative Samples 4 and 5) or have too much sweat-out, i.e., silicone fluid extraction of greater than or equal to 1.000 mg/g (Comparative Sample 2).

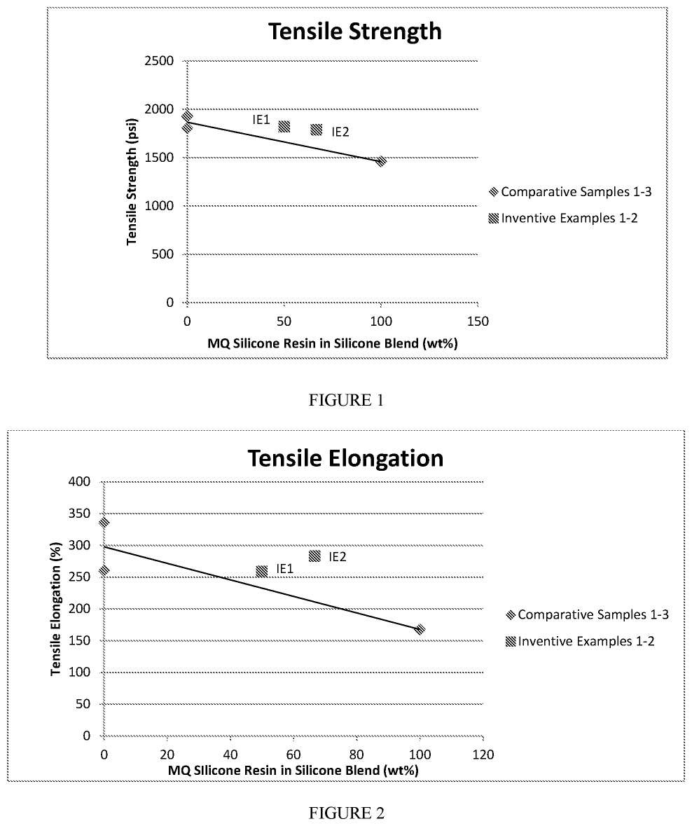

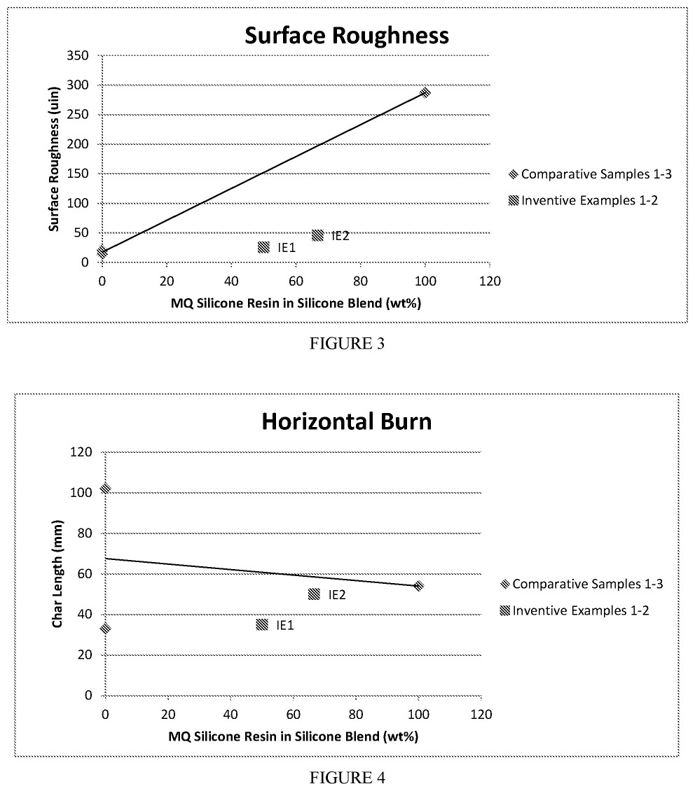

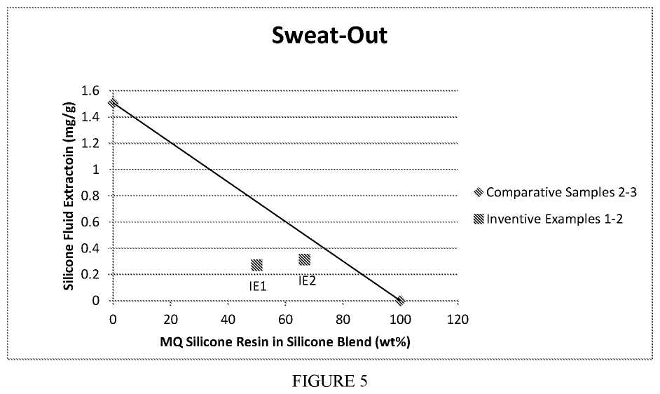

A review of the Inventive Examples and Comparative Examples shows a particularly unexpected improvement in all properties as a result of using the MQ silicone resin/silicone other than an MQ silicone resin blend at an MQ silicone:silicone other than an MQ silicone resin ratio from 1:2 to 2:1. FIGS. 1-5 graphically represent the tensile strength, tensile elongation, surface roughness, horizontal burn and silicone fluid extraction (sweat-out) data as provided in Table 1, above, for CS1-3 and IE1-2. For purposes of comparison, only CS1-3 and IE1-2 are used in the graphs because each of CS1-3 and IE1-2 uses the same MQ silicone resin and/or silicone other than an MQ silicone resin, as applicable. The trend lines based on the data of Comparative Samples 1-3 illustrate the expected value of the physical properties for the Inventive Examples; however, as shown in the graphs, the actual values for the properties of the Inventive Examples fall well above the trend lines for tensile strength and tensile elongation and well below the trend lines for surface roughness, horizontal burn, and sweat-out. In other words, Inventive Examples 1-2 have unexpected greater tensile strength and tensile elongation. Similarly, Inventive Examples 1-2 have unexpected lower surface roughness, horizontal burn and sweat-out.

A review of the Inventive Examples further shows that the specific blend of an MQ silicone resin with a silicone resin other than an MQ silicone resin which is a reactive branched silicone shows enhanced synergistic effects. Inventive Examples 1, 2 and 5 each use a blend of an MQ silicone resin with a reactive branched silicone and have an unexpected combination of improved tensile strength and surface roughness. Each of 1E1-2 and 5 has a tensile strength of greater than 1700 psi and a surface roughness of less than 50 μin.

It is specifically intended that the present disclosure not be limited to the embodiments and illustrations contained herein, but include modified forms of those embodiments including portions of the embodiments and combinations of elements of different embodiments as come within the scope of the following claims.

1. A crosslinkable composition comprising:
(A) a silane-functionalized polyolefin;
(B) a flame retardant;
(C) a silicone blend comprising (i) an MQ silicone resin, and (ii) a silicone other than an MQ silicone resin;
(D) optionally, an antioxidant; and
(E) a silanol condensation catalyst.

2. A jacket layer for a coated conductor, the jacket layer comprising:
(A) a crosslinked silane-functionalized polyolefin;
(B) a flame retardant;
(C) a silicone blend comprising (i) an MQ silicone resin, and (ii) a silicone other than an MQ silicone resin;
(D) optionally, an antioxidant; and
(E) from 0.000 wt % to 10 wt % of a silanol condensation catalyst.

3. The jacket layer of claim 2, wherein the crosslinked silane-functionalized polyolefin is a silane-grafted ethylene-based polymer.

4. The jacket layer of claim 3, wherein the silicone blend has an MQ silicone resin:silicone other than an MQ silicone resin ratio from 9:1 to 1:9.

5. The jacket layer of claim 4, wherein the silicone other than an MQ silicone resin is selected from a branched polysiloxane, a linear polysiloxane, and combinations thereof.

6. The jacket layer of claim 5, wherein the silicone other than the MQ silicone resin is selected from a reactive branched polysiloxane, a non-reactive branched polysiloxane, a reactive linear polysiloxane, and a non-reactive linear polysiloxane.

7. The jacket layer of claim 6, wherein the silicone other than an MQ silicone resin is a branched polysiloxane.

8. The jacket layer of claim 7, wherein the silicone other than an MQ silicone resin is a reactive branched polysiloxane.

9. The jacket layer of claim 8 comprising, based on the total weight of the jacket layer,
(A) from 40 wt % to 60 wt % of the crosslinked silane-functionalized polyolefin;
(B) from 40 wt % to 56 wt % of the flame retardant;
(C) from 1.00 wt % to 3.5 wt % of the silicone blend;
(D) from 0.14 wt % to 0.30 wt % of the antioxidant; and
(E) from 0.000 wt % to 5 wt % of the silanol condensation catalyst.

10. The jacket layer of claim 9, wherein the jacket layer passes the horizontal burn test.

11. The jacket layer of claim 10, wherein the jacket layer has at least one of
(A) a tensile strength from 1500 psi to 1950 psi;
(B) a tensile elongation from greater than 200% to 400%; and
(C) a surface roughness from 0 μin to less than or equal to 50 μm.

12. A coated conductor comprising:
a conductor; and
a coating on the conductor, the coating comprising
(A) a crosslinked silane-functionalized polyolefin;
(B) a flame retardant;
(C) a silicone blend comprising (i) an MQ silicone resin, and (ii) a silicone other than an MQ silicone resin selected from the group consisting of a reactive branched polysiloxane, a non-reactive branched polysiloxane, a reactive linear polysiloxane, a non-reactive linear polysiloxane, and combinations thereof, wherein the MQ silicone resin:silicone other than an MQ silicone resin ratio is from 1:5 to 5:1;
(D) an antioxidant; and
(E) from 0 wt % to 10 wt % of a silanol condensation catalyst.

13. The coated conductor of claim 12, wherein silicone other than the MQ silicone resin is a reactive branched polysiloxane.

14. The coated conductor of claim 13, wherein the coated conductor passes the horizontal burn test.

15. The coated conductor of claim 14, wherein the coating has a tensile elongation from greater than 1700 psi and a surface roughness from 0 μin to less than or equal to 70 μin.
